(19) United States
(12) Patent Application Publication
(10) Pub. No.: US 2020/0186855 A1
(43) Pub. Date: Jun. 11, 2020

(54) Smart remote monitoring system and method

(71) Applicant: Guangzhou Handing Information Technology Company Limited, Guangdong (CN)

(72) Inventors: Wenhui HUANG, Guangdong (CN); Biao PANG, Guangdong (CN)

(73) Assignee: Guangzhou Handing Information Technology Company Limited, Guangdong (CN)

(21) Appl. No.: 16/316,635

(22) PCT Filed: Apr. 13, 2017
(86) PCT No.: PCT/CN2017/000299

§ 371 Date: Jan. 10, 2019

(30) Foreign Application Priority Data
Mar. 7, 2017 (CN) 201710131752.5

(51) Int. Cl. H04N 21/24; H04N 21/442; H04N 21/258

(52) U.S. Cl. CPC H04N 21/2408; H04N 21/25866; H04N 21/442

(57) ABSTRACT

A smart remote monitoring system and method is provided. The system has a monitoring terminal electrically connected with a controlled device and a remote monitoring management platform electrically connected with the monitoring terminal. The method is discovering effective video streams of the controlled device by using a trigger mechanism of the monitoring terminal, and using the remote monitoring management platform to receive the effective video streams, and managing and controlling the monitoring terminal.

### BACKGROUND OF THE INVENTION

The present invention relates to a smart remote monitoring system and method.

As known, a main computer or an embedded system gives out a wide array of video signals which are connected to a VGA or HDMI display (or TV) to output corresponding video signals so that a user can watch. The market has the following demands: under the premise that watching a video through a local display is not affected, corresponding output signals of a format like VGA or HDMI are required to be remotely transmitted to the internet through a network, so that a user can remotely watch the corresponding output signals; further, it is also required that the user can remotely control a local main computer or embedded system. The solution generally provided by the market to meet these demand is to use a switcher product to change the VGA or HDMI output of the main computer or the embedded system to a 2-way output, wherein one way is connected to the local display, and another way has the video signals imported to a commonly available monitoring device in the market; through encoding, decoding and network transmission of the monitoring device, local signals are transmitted to a remote network.

The above solution has the following disadvantages:

1. Physically complicated: Not only a specific switcher product should be used, connection with a monitoring device is also required which involves complicated wiring. Also, the solution is not multi-functional.

2. Since a local network is required, a switch is generally required in the prior art for network exchange. Therefore, a switch has to be purchased which additionally bulk up the system physically.

### BRIEF SUMMARY OF THE INVENTION

It is an object of the invention to provide a smart remote monitoring system and method that require only one embedded main panel to convert video signals from analog signals to digital signals and then input the digital video signals to a CPU capable of encoding and decoding. The CPU is also equipped with network MAC function to transmit the video signals to networking ports through externally connected PHY chip circuits. Also, the main panel is integrated with a switch chip circuit which prevents an additional switch required to be provided external to the system. The present invention provides the following technical solution:

A smart remote monitoring system, comprising a monitoring terminal electrically connected with a controlled device and a remote monitoring management platform electrically connected with the monitoring terminal; the monitoring terminal comprises an Analog-Digital (AD) switch module, a processing module, a switch and a communication bus;

an analog input end of the AD switch module is electrically connected with a signal input socket to receive video signals from the controlled device; the signal input socket is also electrically connected with a signal output socket to transmit the video signals to the controlled device; the AD switch module is also electrically connected with an electrical level switch module that switches the electrical level of the signal output socket;

the processing module is integrated with an image smart detection module and encoders; the image smart detection module receives the video signals according to trigger mechanism; the encoders encode the video signals received upon trigger;

the switch is electrically connected with the processing module through a transceiver; the switch achieves electrical connection between the processing module and the remote monitoring management platform, and provides more than one networking port socket;

the communication bus comprises a USB device port to be connected with a mouse of the controlled device to achieve control of the controlled device via the remote monitoring management platform.

Preferably, the remote monitoring management platform comprises a database and a message broker;

the database stores platform users and users' permissions data, monitoring terminal and configuration data, historical video data and operation diary;

the message broker gives an alarm or an alert upon receipt of the video signals by the image smart detection module according to the trigger mechanism.

Preferably, the processing module uses a Hisilicon HI3516A chip; an output end of the AD switch module is electrically connected with a Lvds/Cmos input end of the Hisilicon H13516A chip; an ETH output end of the Hisilicon H13516A chip is electrically connected with an input end of the transceiver.

Preferably, the AD switch module uses an ADI ADV7181D chip; the signal input socket is coupled to an analog input end of the ADI ADV7181D chip through a capacitor; an HS pin and a VS pin of the signal input socket are electrically connected with an HS_IN pin and HS_OUT pin of the ADI ADV7181D chip respectively through electrical level switch modules.

Preferably, the transceiver uses a RELTEK RTL8211E chip; the ETH output end of the Hisilicon HI3516A chip is electrically connected with an input end of the RELTEK RTL8211E chip; an output end of the RELTEK RTL8211E chip is electrically connected with an input end of the switch.

Preferably, the switch uses a RELTEK RTL8367N chip; an input end of the RELTEK RTL8367N chip is coupled to the output end of the RELTEK RTL8211 E chip through a capacitor; the RELTEK RTL8367N chip is electrically connected with more than one gigabit networking port socket each being internally provided with an isolation transformer.

A smart remote monitoring method, comprising:

discovering effective video streams of the controlled device by using the trigger mechanism of the monitoring terminal which is electrically connected with the controlled device;

using the remote monitoring management platform which is electrically connected with the monitoring terminal to receive the effective video streams, and managing and controlling the monitoring terminal.

Preferably, discovering the effective video streams comprises the following steps:

S101: starting a monitoring procedure of the monitoring terminal, and activating the trigger mechanism used for discovering effective video streams;

S102: when the trigger mechanism responds upon discovery of an effective video stream, sending an effective video message to the remote monitoring management platform by using the monitoring terminal;

S103: generating an encoded video stream by using the monitoring terminal, and waiting for the remote monitoring management platform to retrieve the encoded video stream;

in the above steps, the trigger mechanism is operated based on time trigger or image trigger.

Preferably, receiving the effective video stream comprises the following steps:

S201: starting procedures of the remote monitoring management platform, and activating the message broker;

S202: monitoring all effective video messages potentially transmitted from the monitoring terminal by using the remote monitoring management platform;

S203: when an effective video message is spotted, activating streaming process to retrieve the encoded video stream of the monitoring terminal;

S204: generating video data, and modifying an associated database table.

The present invention has the following characterizing features:

Smart monitoring that does not require manpower to be on duty: The present invention solves the problems in prior art safety and protection systems in which manpower is required to be on duty, the on-duty staff may be negligent to important alerts due to fatigue, ineffective video which looks like static images may be recorded, and high bandwidth and large storage volume are required for network transmission. The monitoring terminal according to the present invention can make use of image detection or behavior recognition to automatically recognize effective videos based on user's settings and to send real-time message to the platform. When the platform receives a message, an alert message is automatically sent out and the video stream will be recorded and saved automatically. Users can watch the video afterwards, and can also activate remote monitoring function immediately to achieve online remote control of the controlled device.

Watch and operate: The monitoring terminal can use a stream server and be driven by 2-in-1 Gadget keyboard and mouse. A user can operate the controlled device remotely, and multiple users may be allowed to monitor and operate the controlled device. Of course, only one user may be allowed to operate remotely at one time during actual use in order to prevent dashes.

Low network bandwidth and small storage volume: H.264 and H.265 can be used for encoding in the application of smart monitoring of the present invention. As such, occupation of network bandwidth and generation of video file occur only with effective videos. Accordingly, the problems of high bandwidth occupation and a large quantity of ineffective videos existing in prior art monitoring system are completely solved.

To ensure operation safety, all messages are encrypted during transmission. Video streams may be encrypted or may not be encrypted depending on practical needs.

The terminal and the platform do not store any user's operation data.

User's terminal of the platform does not require installation of any software or inserts. Only a browser which supports HTML5 is required.

System configuration does not change any operation system or networking frame, thereby achieving nil coupling fast configuration.

### BRIEF DESCRIPTION OF THE DRAWINGS

The drawings described herein are intended for better understanding of the present invention and form part of the present invention. However, the drawings should not improperly limit the present invention.

FIG. 1 is a logic diagram of a monitoring terminal of the present invention.

FIG. 2 is a logic diagram of a remote monitoring management platform of the present invention.

FIGS. 3 and 4 are circuit diagrams of a processing module of the present invention.

FIG. 5 is a circuit diagram of an analog-digital switch module of the present invention.

FIG. 6 is a circuit diagram of a transceiver of the present invention.

FIG. 7 is a circuit diagram of a switch of the present invention.

FIG. 8 shows the steps of discovering an effective video stream according to the present invention.

FIG. 9 shows the steps of receiving the effective video stream according to the present invention.

### DETAILED DESCRIPTION OF THE INVENTION

The present invention will be described in detail below with reference to an embodiment and the accompanying drawings. Illustrative examples and explanation in the embodiment to be described below are intended to facilitate understanding of the present invention but not intended to limit the present invention.

### Embodiment

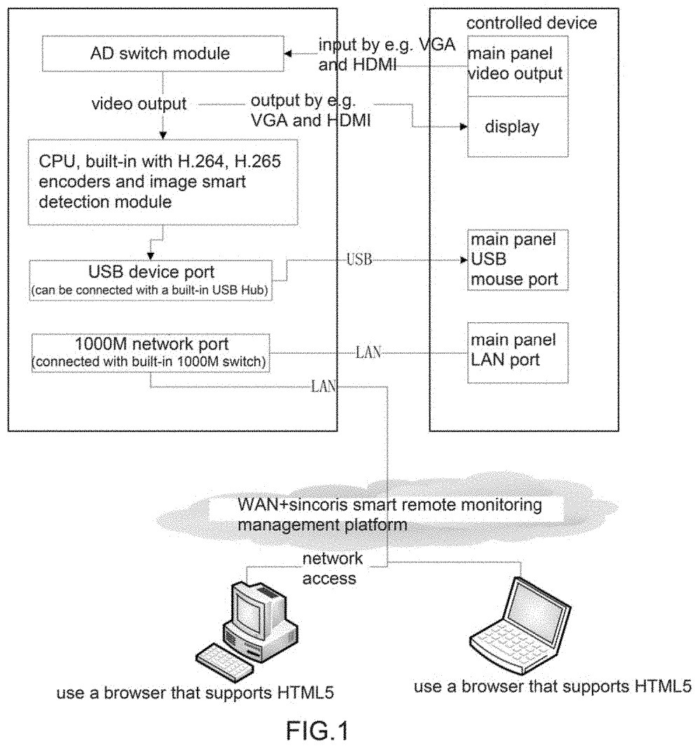

As shown in FIG. 1, a smart remote monitoring system comprises a monitoring terminal electrically connected with a controlled device (a computer for operation) and a remote monitoring management platform electrically connected with the monitoring terminal. The monitoring terminal comprises an Analog-Digital (AD) switch module, a processing module, a switch and a communication bus. An analog input end of the AD switch module is electrically connected with a signal input socket to receive video signals from the controlled device so as to collect display signals of the controlled device. The signal input socket is also electrically connected with a signal output socket to transmit the video signals to the controlled device. The AD switch module is also electrically connected with an electrical level switch module that switches the electrical level of the signal output socket. The processing module is integrated with an image smart detection module and encoders. The image smart detection module receives the video signals according to trigger mechanism. The encoders encode the video signals received upon trigger. The switch is electrically connected with the processing module through a transceiver. The switch achieves electrical connection between the processing module and the remote monitoring management platform, and provides more than one networking port socket; the communication bus comprises a USB device port (can be built-in with a USB hub to allow a plurality of USB devices to be inserted to the controlled device) to be connected with a mouse of the controlled device to achieve control of the controlled device via the remote monitoring management platform.

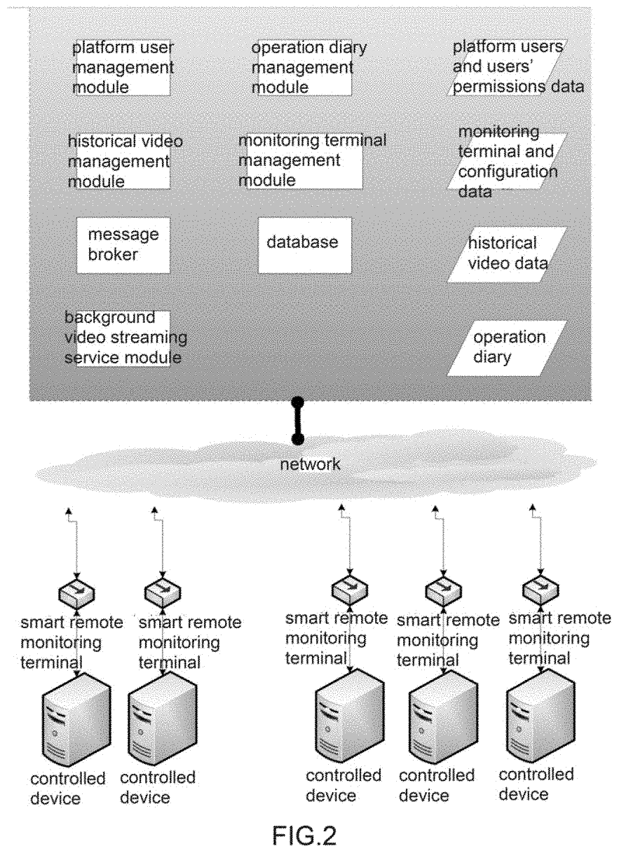

As shown in FIG. 2, a system of the remote monitoring management platform is based on SpringMVC B/S framework, and it is recommended that resources from open source are used in all aspects. Requirements:

Operation system: e.g. Linux, Windows are acceptable.

Database: e.g. MySQL

Message broker: e.g. RabbitMQ

Java environment: e.g. java 1.8

Web server: e.g. Tomcat

Streaming service: e.g. ffmpeg is recommended.

The remote monitoring management platform comprises a database and a message broker; the database stores platform users and users' permissions data, monitoring terminal and configuration data, historical video data and operation diary, and correspondingly provides a platform user management module, a monitoring terminal management module, a historical video management module, an operation diary management module and a background video streaming service module. The message broker gives an alarm or an alert upon receipt of video signals by the image smart detection module according to trigger mechanism.

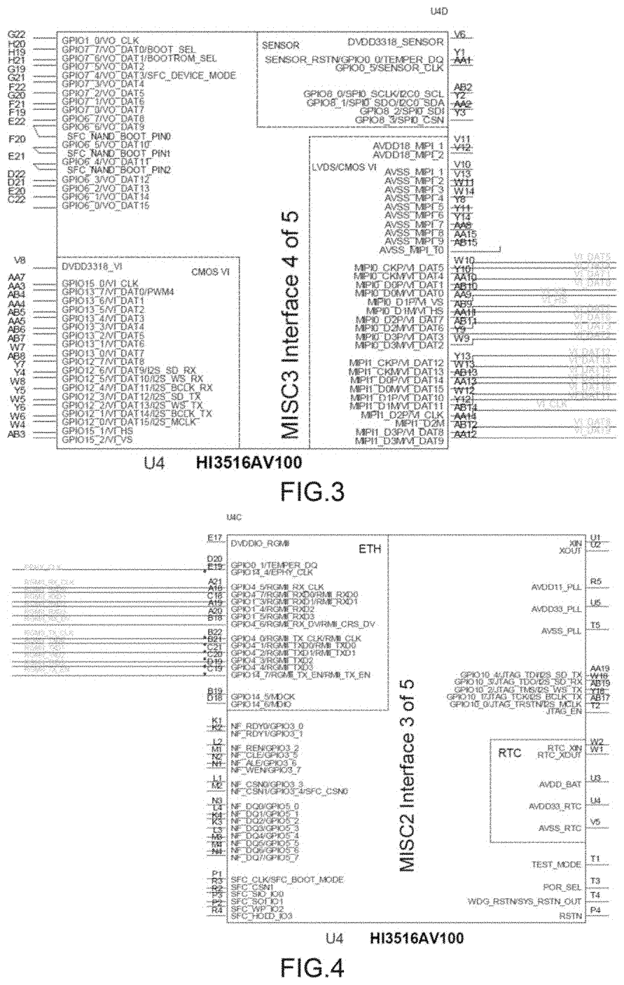

As shown in FIG. 3 and FIG. 4, the processing module uses a Hisilicon HI3516A chip (U4). The Hisilicon HI3516A chip has a very powerful performance in encoding and decoding. Parallel video data signals output by the AD switch module can be transmitted to a video input interface of the Hisilicon H13516A chip, and the Hisilicon H13516A chip will encode the video. An output end of the AD switch module is electrically connected with a Lvds/Cmos input end of the Hisilicon H13516A chip (U4). A ETH output end of the Hisilicon H13516A chip (U4) is electrically connected with an input end of the transceiver.

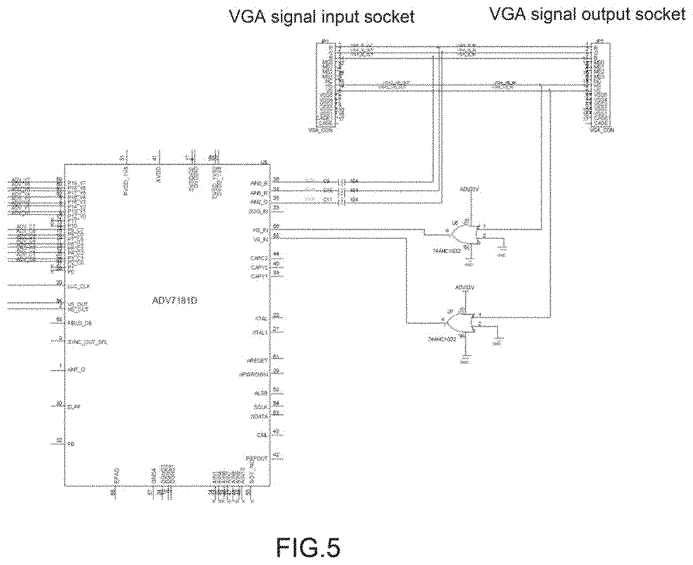

As shown in FIG. 5, The AD switch module uses a hardware level ADI ADV7181D chip (U5). ADI ADV7181D chip (U5) is a specific decoding chip provided by Analog Device Inc. that switches analog RGB to parallel digital interface signals. It can switch analog video signals of formats like VGA, HDMI to 16-digit parallel digital signals. The signal input socket (JP1) provides a socket for the signal output socket (JP2), and is also coupled to an analog input end of the ADI ADV7181D chip through a capacitor, such that the analog R, G, B signals are input to the analog input end of the ADI ADV7181D chip, and an HS pin and a VS pin of the signal input socket (JP1) are electrically connected with an HS_IN pin and HS_OUT pin of the ADI ADV7181D chip (U5) respectively through electrical level switch modules (U6, U7), such that 5V electrical level of the HS pin and the VS pin is switched to 3.3V of the ADI ADV7181D chip (U5).

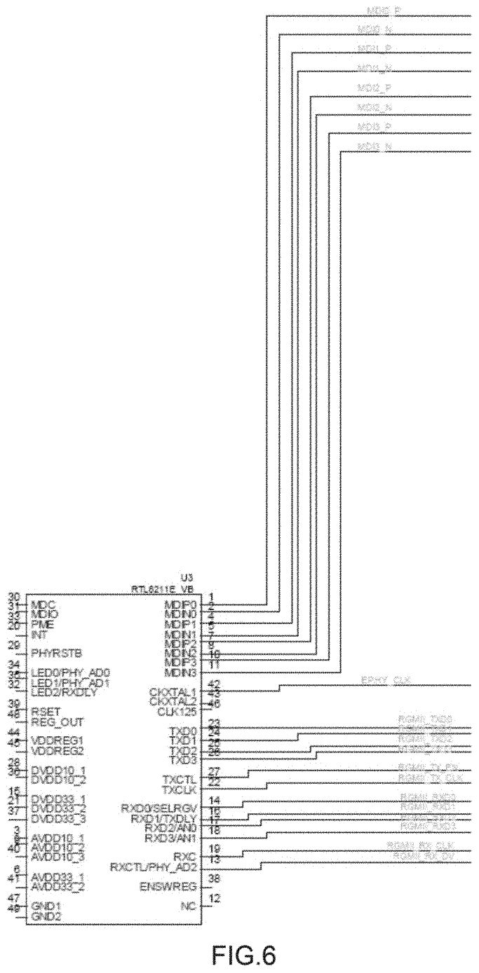

As shown in FIG. 6, the transceiver uses a RELTEK RTL8211E chip (U3), which is a gigabit port transceiver chip provided by Reltek LLC. The ETH output end of the Hisilicon HI3516A chip (U4) is electrically connected with an input end of the RELTEK RTL8211E chip (U3). An output end of the RELTEK RTL8211E chip (U3) is electrically connected with an input end of the switch. Since the Hisilicon H13516A chip (U4) has network MAC function, a MAC output interface of the Hisilicon H13516A chip (U4) is connected with a corresponding port of the RELTEK RTL8211E chip (U3).

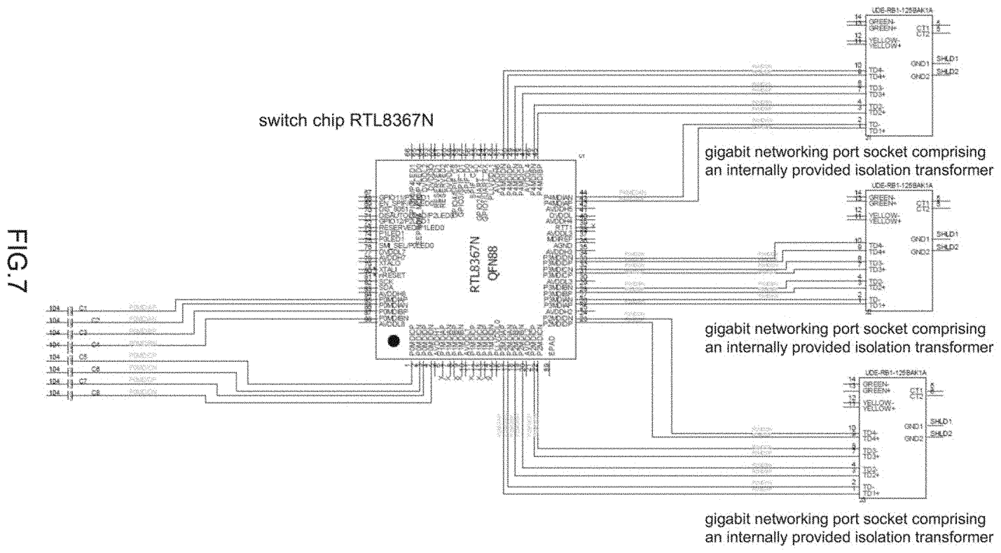

As shown in FIG. 7, the switch uses a RELTEK RTL8367N chip (U1). An input end of the RELTEK RTL8367N chip (U1) is coupled to the output end of the RELTEK RTL8211E chip (U3) through a capacitor. The RELTEK RTL8367N chip (U1) connects a gigabit output port of the RELTEK RTL8211E chip (U3) to a switch interface of one way of the RELTEK RTL8367N chip (U1), and other network ports of the RELTEK RTL8367N chip (U1) are connected with networking port sockets comprising network transformers, thereby achieving the function of the switch. J1, J2, J3 are gigabit networking transformers integrated with isolation transformers. The gigabit networking transformers are specifically the model RB1-125BAK1A manufactured by UDE corporation of Taiwan.

Based on the embodiment described above, the present invention also provides a smart remote monitoring method which comprises discovering effective video streams of the controlled device by using the trigger mechanism of the monitoring terminal which is electrically connected with the controlled device; using the remote monitoring management platform which is electrically connected with the monitoring terminal to receive the effective video streams, and managing and controlling the monitoring terminal.

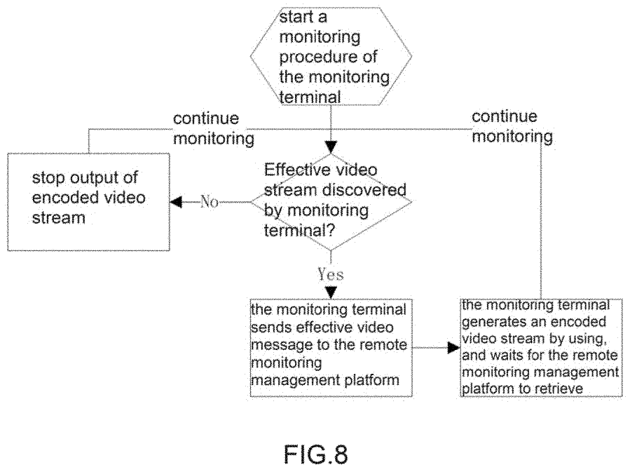

As shown in FIG. 8, discovering the effective video streams comprises the following steps:

S101: starting a monitoring procedure of the monitoring terminal, and activating the trigger mechanism used for discovering effective video streams;

S102: when the trigger mechanism responds upon discovery of an effective video stream, sending an effective video message to the remote monitoring management platform by using the monitoring terminal;

S103: generating an encoded video stream by using the monitoring terminal, and waiting for the remote monitoring management platform to retrieve the encoded video stream.

In the above steps, the trigger mechanism is operated based on time trigger or image trigger.

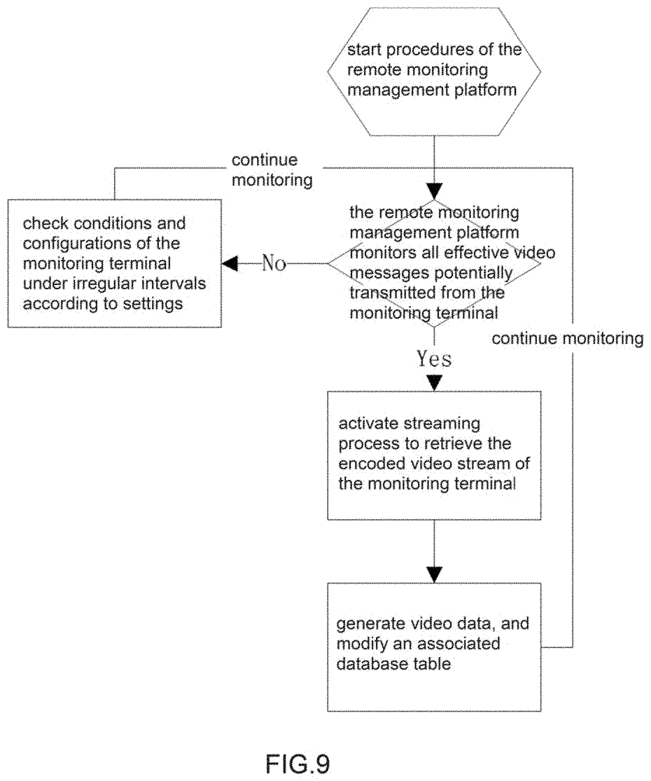

As shown in FIG. 9, receiving the effective video stream comprises the following steps:

S201: starting procedures of the remote monitoring management platform, and activating the message broker;

S202: monitoring all effective video messages potentially transmitted from the monitoring terminal by using the remote monitoring management platform;

S203: when an effective video message is spotted, activating streaming process to retrieve the encoded video stream of the monitoring terminal;

S204: generating video data, and modifying an associated database table.

The technical solution provided by an embodiment of the present invention is described in detail above. A specific example is given to explain the concept and the ways of implementation of the embodiment as described. The embodiment described above is intended only to facilitate understanding of the concept of the embodiment. Changes with respect to the ways and scopes of implementation of the present invention can be made based on the teachings of the present embodiment by a person skilled in this field of art. In summary, the description given above should not limit the present invention.

What is claimed is:

1. A remote monitoring system, comprising a monitoring terminal electrically connected with a controlled device and a remote monitoring management platform electrically connected with the monitoring terminal; wherein:
the monitoring terminal comprises an Analog-Digital (AD) switch module, a processing module, a switch and a communication bus;
an analog input end of the AD switch module is electrically connected with a signal input socket to receive video signals from the controlled device; the signal input socket is also electrically connected with a signal output socket to transmit the video signals to the controlled device; the AD switch module is also electrically connected with an electrical level switch module that switches the electrical level of the signal output socket;
the processing module is integrated with an image smart detection module and encoders; the image smart detection module receives the video signals according to trigger mechanism; the encoders encode the video signals received upon trigger;
the switch is electrically connected with the processing module through a transceiver; the switch achieves electrical connection between the processing module and the remote monitoring management platform, and provides more than one networking port socket;
the communication bus comprises a USB device port to be connected with a mouse of the controlled device to achieve control of the controlled device via the remote monitoring management platform.

2. The remote monitoring system of claim 1, wherein:
the remote monitoring management platform comprises a database and a message broker;
the database stores platform users and users' permissions data, monitoring terminal and configuration data, historical video data and operation diary;
the message broker gives an alarm or an alert upon receipt of the video signals by the image smart detection module according to the trigger mechanism.

3. The remote monitoring system of claim 2, wherein:
the processing module uses a Hisilicon HI3516A chip; an output end of the AD switch module is electrically connected with a Lvds/Cmos input end of the Hisilicon HI3516A chip; an ETH output end of the Hisilicon H13516A chip is electrically connected with an input end of the transceiver.

4. The remote monitoring system of claim 3, wherein:
the AD switch module uses an ADI ADV7181D chip; the signal input socket is coupled to an analog input end of the ADI ADV7181D chip through a capacitor; an HS pin and a VS pin of the signal input socket are electrically connected with an HS_IN pin and HS_OUT pin of the ADI ADV7181D chip respectively through electrical level switch modules.

5. The remote monitoring system of claim 3, wherein:
the transceiver uses a RELTEK RTL8211E chip; the ETH output end of the Hisilicon H13516A chip is electrically connected with an input end of the RELTEK RTL8211E chip; an output end of the RELTEK RTL8211E chip is electrically connected with an input end of the switch.

6. The remote monitoring system of claim 5, wherein:
the switch uses a RELTEK RTL8367N chip; an input end of the RELTEK RTL8367N chip is coupled to the output end of the RELTEK RTL8211E chip through a capacitor; the RELTEK RTL8367N chip is electrically connected with more than one gigabit networking port socket each being internally provided with an isolation transformer.

7. A remote monitoring method, comprising:
discovering effective video streams of a controlled device by using a trigger mechanism of a monitoring terminal which is electrically connected with the controlled device;
using a remote monitoring management platform which is electrically connected with the monitoring terminal to receive the effective video streams, and managing and controlling the monitoring terminal.

8. The remote monitoring method of claim 7, wherein discovering the effective video streams comprises the following steps:
S101: starting a monitoring procedure of the monitoring terminal, and activating the trigger mechanism used for discovering the effective video streams;
S102: when the trigger mechanism responds upon discovery of an effective video stream, sending an effective video message to the remote monitoring management platform by using the monitoring terminal;
S103: generating an encoded video stream by using the monitoring terminal, and waiting for the remote monitoring management platform to retrieve the encoded video stream.

9. The remote monitoring method of claim 8, wherein the trigger mechanism is operated based on time trigger or image trigger.

10. The remote monitoring method of claim 8, wherein receiving the effective video stream comprises the following steps:
S201: starting procedures of the remote monitoring management platform, and activating the message broker;
S202: monitoring all effective video messages potentially transmitted from the monitoring terminal by using the remote monitoring management platform;
S203: when the effective video message is spotted, activating streaming process to retrieve the encoded video stream of the monitoring terminal;
S204: generating video data, and modifying an associated database table.
